(19) United States
(12) Patent Application Publication
(10) Pub. No.: US 2008/0087379 A1
(43) Pub. Date: Apr. 17, 2008

(54) REPOSITIONABLE ADHESIVE-BACKED PHOTOGRAPHS AND PHOTO MEDIA AND METHODS OF MAKING

(75) Inventors: Jonathan P. Kitchin, Austin, TX (US); Manisha Sarkar, Austin, TX (US); Timothy J. O'Leary, White Bear Lake, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/854,633

(22) Filed: Sep. 13, 2007

Related U.S. Application Data
(60) Provisional application No. 60/829,024, filed on Oct. 11, 2006.

(51) Int. Cl. B29C 65/00; B32B 7/12

(52) U.S. Cl. 156/278; 156/327; 156/60

(57) ABSTRACT

A method of making a repositionable adhesive backed photo media is provided. The method includes the steps of (a) providing an imageable substrate or providing a photograph; (b) providing an attachment mechanism having a carrier film with opposing first and second surfaces; a thermally activating adhesive disposed on the first surface; a repositionable adhesive disposed on the second surface; and a liner disposed on the repositionable adhesive; (c) stacking the imageable substrate or stacking the photograph with the attachment mechanism; and (4) exposing the stack to heat causing the thermally activating adhesive to bond to the imageable substrate or the photograph.

### CROSS-REFERENCE TO RELATED APPLICATIONS

This application claims priority to U.S. Provisional application 60/829024 filed on Oct. 11, 2006. This application is also related to application 63603US002, entitled Adhesive Composite, application 63604US002, entitled Photographic Print with Adhesive Composite, and application 63605US002, entitled Method of Making a Photographic Print with Adhesive Composite, all applications being filed on even date herewith.

### BACKGROUND

With the popularity of digital cameras and the availability of desktop printers, many consumers today have the flexibility of previewing digital photos and printing only the ones they desire in their home. While home printing has become more common practice, commercial printing of the consumers' digital pictures continues to be an option for those consumers who prefer to send their digital photos to a photo processor.

Commercial printing takes two general forms. First, in-store digital mini photo labs allow consumers to select their own pictures for processing when they insert a memory card from the camera into a touch screen kiosk. Instructions on the kiosk appear and walk the consumer through the process. This first type of commercial printing can be referred to as “retail” photo processing. Second, wholesale photo processing labs provide mail order fulfillment of requests for digital prints. Typically, consumers submit their requests for photographic prints to photo hosting websites on the Internet. This second type of commercial printing can be referred to as “wholesale” photo processing.

Both retail and wholesale photo processing operations can produce digital prints on conventional photosensitive silver halide photo paper. The process typically requires image wise scanning with red, green, and blue light followed by wet chemical processing to produce an image. The wet chemical processing typically involves developing, bleaching and fixing, washing and stabilizing, and finally drying of the resulting silver halide photo paper. Black and white as well as color photographs can be produced using this process. Conventional silver halide photo processing continues to be common practice because it uses entrenched technology and because of the relatively low cost and high quality prints that result from it.

Some skilled in the art have devised a process of applying an adhesive, which is typically protected by a liner, to photo paper prior to the wet chemical processing steps. In such a case, the adhesive and the liner need to withstand, not to interfere, and not to contaminate the chemicals used in the process. Exemplary references directed to this method and articles made therefrom includes CH 568857; U.S. Pat. No. 6,045,965 (Cournoyer et al.); U.S. Pat. No. 6,514,646 (Nair et al.); and U.S. Pat. No. 6,645,690 (Nair et al.).

Instead of developing an adhesive system that can withstand the wet chemical processing, a photo processor, however, can use alternate techniques to make adhesive-backed silver halide photographs after the wet chemical processing. The photo processor can use, for example, commercially available adhesive transfer tapes. An adhesive transfer tape typically consists of an adhesive coated on a release liner. The adhesive may be a repositionable pressure sensitive adhesive (PSA). Such adhesive transfer tapes can be applied to a backside (i.e., the non-imaged side) of the silver halide photograph. The liner stays in place until the consumer wants to display the photograph, upon which time she or he will peel back and discard the liner to expose the adhesive and attach the photograph to a desired display surface. In practice, however, adhesive transfer tapes, especially repositionable PSA transfer tapes, do not work well on the backside of silver halide photographs because the backside has a layer of polyethylene. The transfer adhesive adheres poorly to the polyethylene. Upon removal of the photograph from an intended display surface, such as varnished wood, a painted wall, or glass, the transfer adhesive can de-bond from the photograph backside and transfer to the display surface, a highly undesirable effect. To increase the anchorage between the transfer adhesive and the backside of the silver halide print, a prime coat can be used between the two layers. Such a coating would add an extra step in the process that may be time consuming and may not be cost effective.

Some skilled in the art have described articles containing a PSA, whether repositionable or not, and methods of making them. Illustrative references include Patent Disclosure DE 2515330; U.S. Pat. No. 4,201,613 (Olivieri et al.), U.S. Pat. No. 4,285,999 (Olivieri et al.), U.S. Pat. No. 4,507,166 (Posner), U.S. Pat. No. 6,403,185 (Neuburger et al.), and U.S. Pat. No. 7,087,280 (Neuburger); US Patent Application Publications US 2004/0137183 and US 2006/0057326, and PCT Publication WO 1999/012466.

Silver halide photographs have a tendency to curl in environments with high humidity (e.g., greater than about 75% relative humidity) or low humidity (e.g., less than about 25% relative humidity). Typically, the edges or corners of the photograph will curl such that it will no longer lie planar to a display surface. With extended exposure to the high or low humidity conditions, the photograph may curl through a ninety degree angle or more. Thus, any adhesive used with photographs should not exasperate but instead should help alleviate the curl that photographs may experience.

### SUMMARY

The present invention pertains to methods of making repositionable adhesive-backed photographs. In particular, the present invention pertains to the use of an attachment mechanism that includes a thermally activating adhesive, a carrier film, and a repositionable adhesive that, when used with a photograph, transforms it into a product that can be readily displayed on and removed from a surface.

In one aspect, the present invention provides a solution for converting a non-adhesive silver halide photograph into a repositionable adhesive-backed photograph. The conversion relies on the attachment mechanism. In another aspect, the present invention also provides a solution for converting any pre-printed, non-adhesive backed photograph that was digitally imaged, into a repositionable adhesive backed photograph. In yet another aspect, the present invention further provides a solution for creating a repositionable adhesive backed photo media that can subsequently be digitally imaged.

As used herein, the terms:

“photograph” means generally an article that results from an image produced (such as, e.g., scanned) on a substrate, such as photo media;

“digitally imaged” includes inkjet printing (commonly desktop printers), thermal dye transfer printing, and electrophotographic printing, the latter to include dry toner based printers (commonly referred to as “laser printers” or “color laser printers”) and liquid toner based printers (sometimes referred to as “digital presses”); and

“thermally activating adhesive” means generally a material that is non-tacky at room temperature (of about 23° C.) but softens and may even become molten at elevated temperature to form a bond with a substrate upon which it came into contact, after which time it is referred to as a “thermally activated adhesive.”

In one aspect, the present invention pertains to a method of making a repositionable adhesive backed photo media. The method comprises the steps of (a) providing an imageable substrate having first and second opposing surfaces, the first surface capable of being imaged, or providing a photograph having opposing first and second surfaces, the first surface containing an image, the second surface comprising a polyolefin layer; (b) providing an attachment mechanism comprising a carrier film having opposing first and second surfaces; a thermally activating adhesive disposed on the first surface of the carrier film; a repositionable adhesive disposed on the second surface of the carrier film; and a liner disposed on the repositionable adhesive; (c) stacking the imageable substrate or the photograph with the attachment mechanism such that its thermally activating adhesive contacts the second surface of the imageable substrate or the second surface of the photograph; and (d) exposing the stack to heat causing the thermally activating adhesive to bond to the second surface of the imageable substrate or the second surface of the photograph.

In yet another aspect, the present invention pertains to a kit comprising (a) a plurality of imageable substrates having first and second opposing major surfaces, the first surface capable of being imaged; and (b) a plurality of attachment mechanism, each comprising a carrier film having opposing first and second surfaces, a thermally activating adhesive disposed on the first surface and a repositionable adhesive disposed on the second surface of the carrier film and a liner disposed on the repositionable adhesive.

Once done with displaying the photograph, the consumer can archive it, if desired. In this way, photographs can be updated on a regular basis and they can be displayed quickly without the need to use frames or alternative hardware. Photographs can also be displayed on any horizontal or vertical surface that the repositionable adhesive can be adhered, such as, e.g., refrigerators (without the need for using magnets), wood or plastic surfaces (without the need for using additional tape), fabrics, walls, and windows. The repositionable adhesive used in the present invention provides good adhesion to the intended surface and yet will not leave residue adhesive once the photograph has been removed.

In this document, the term “about” is presumed to modify all numeric values.

### BRIEF DESCRIPTION OF THE DRAWINGS

The present invention can be further described with reference to the following drawings, wherein:

FIG. 1 is a perspective view of an exemplary repositionable adhesive backed photo media;

FIG. 2 is a perspective view of an exemplary repositionable adhesive backed photograph; and

FIGS. 3 and 4 are schematic views of exemplary processes that may be used to make an adhesive backed repositionable media or photograph of the present invention.

These figures are idealized, are not drawn to scale, and are intended merely for illustrative purposes.

### DETAILED DESCRIPTION

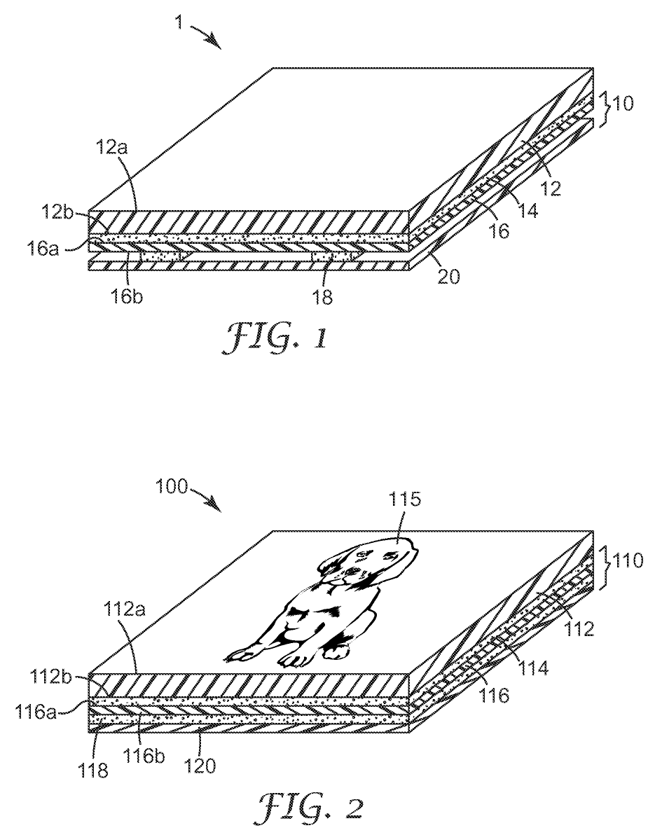

FIG. 1 shows a perspective view of an exemplary repositionable adhesive backed photo media 1. The photo media includes imageable substrate 12 having opposing first and second surfaces, 12a and 12b respectively. Attachment mechanism 10 includes carrier film 16 having opposing first and second surfaces, 16a and 16b. Thermally activated adhesive 14 lies on the first side of the carrier film. Repositionable pressure sensitive adhesive (PSA) 18 lies on the second surface of the carrier film. In this particular embodiment, the thermally activated adhesive covers substantially the entire first surface while the repositionable PSA covers only a portion of the second surface of the carrier film. The thermally activated adhesive, however, can cover only a portion of the first surface of the carrier film, if desired. The repositionable PSA can be, and is shown in, the form of two stripes. Any number of repositionable PSA stripes can be used. Liner 20 protects the repositionable PSA. Because the thermally activated adhesive has been exposed to heat, it is bonded to the second surface of the imageable substrate. In this particular construction, the first surface of the imageable substrate may be digitally imaged before it is laminated to the attachment mechanism or, alternately, after it has been laminated to the attachment mechanism.

FIG. 2 shows a perspective view of an exemplary repositionable adhesive backed photograph 100. The photograph includes a substrate 112 having opposing first and second surfaces, 112a and 112b respectively. An image 115 lies on the first surface of the substrate. The second surface of the photograph optionally includes a polyolefin layer (not shown). In one embodiment, the polyolefin layer is a polyethylene. An attachment mechanism 110 includes carrier film 116 having opposing first and second surfaces, 116a and 116b. A thermally activated adhesive 114 lies on the first surface while a repositionable PSA lies on the second surface of the carrier film. In this particular embodiment, the thermally activated adhesive covers substantially the entire first surface and the repositionable PSA covers substantially the entire second surface of the carrier film. Liner 120 protects the repositionable PSA.

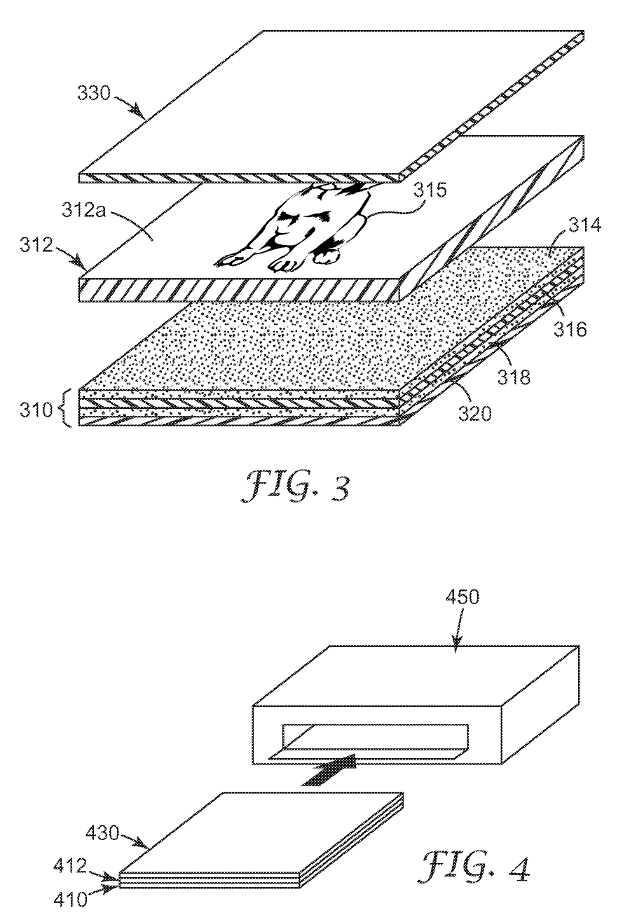

FIG. 3 shows a schematic view of an exemplary process for use in the present invention that includes the steps of providing substrate 312, providing attachment mechanism 310 and optionally providing a heat resistant cover sheet 330. Any material that provides protection to the substrate can be used as the heat resistant cover sheet. In one process, polyimide, polyester, or paper can be used. The substrate has first surface 312a and an opposing second surface (not shown). In this particular figure, the first surface of the substrate 312 includes image 315. While this figure shows an imaged substrate, as described above, this invention can also be practiced with a non-imaged substrate. The attachment mechanism includes a carrier film 316 having opposing first and second surfaces, a thermally activating adhesive 314 disposed on the first surface of the carrier film, a repositionable PSA 316 disposed on the second surface of the carrier film, and a liner 320 protecting the repositionable PSA. The layers are stacked so that the substrate lies between the optional heat resistant cover sheet and the attachment mechanism with the thermally activating adhesive facing the second surface of the substrate.

FIG. 4 shows another schematic view of an exemplary process for use in the present invention. Three layers are aligned and stacked on top of one another so that imaged substrate (i.e., the photograph) or imageable substrate 412 is sandwiched between heat resistant film 430 and attachment mechanism 410 to form a composite. The next step in the process involves feeding stack into laminator 450, generally in the direction indicated by the arrow. The laminator subjects the stack to a temperature greater than about room temperature (23° C.) and less than about 175° C. This temperature range activates the thermally activating adhesive from its initial non-tacky state to a softened and possibly molten state. A variety of laminators are commercially available, such as without limitation, from General Binding Corporation (GBC) under the HeatSeal® laminating systems, as described in the www.GBC.com website. A subsequent step involves laminating the composite so that the thermally activating adhesive bonds to the second surface of the imaged substrate or the imageable substrate. After the lamination step, the heat resistant cover layer is removed. Upon use, the consumer removes the liner and attaches the now adhesive backed photograph to a desired display surface, such as a refrigerator door, a wall, a window, and the like.

Turning to the construction of the repositionable adhesive backed photographs and photo media, each of the various components will be discussed in detail including the imageable substrate and the attachment mechanism.

The imageable substrate that can be used in the present invention can be single or multilayer in construction and contains one major surface that is capable of being imaged, either digitally imaged or imaged via the conventional silver halide wet chemical process. The imageable substrate can be paper based or polymer based. Paper based imageable substrates have a basis weight in the range of about 125 to 210 gram/square meter (g/m²). As described above with reference to the figures, the imageable substrate can be first laminated to the attachment mechanism and then digitally imaged. Alternatively, the imageable substrate is first imaged, and then laminated to the attachment system. In the latter approach, one suitable substrate is the silver halide photo paper that has been processed through the wet chemical process to yield a photograph.

A silver halide photo paper typically contains a cellulose fiber paper support that has a polyolefin resin extrusion laminated on at least one major surface of the paper and more commonly on both major surfaces. A common polyolefin material used in the industry is polyethylene. The coated paper then goes through a series of processing steps where various chemicals are coated to a first major surface of the paper resulting in an image receptive side, to form the photosensitive silver halide chemistry. U.S. Pat. No. 6,045,965 (Cournoyer et al.) describes the various coatings and chemistries used to produce photosensitive silver halide paper. Manufacturers such as Eastman Kodak Company and Fuji Photo Film Company are well known suppliers silver halide photo paper. A second major surface of the paper (opposing the first major surface) is the backside. On the backside, over the polyolefin coating, there may be additional coatings that modify the surface properties of the polyolefin (such as, e.g., its coefficient of friction or its electrical resistivity).

Suitable thermally activating adhesive that can be used in the present invention includes polyamides, polyolefin homopolymers (such as, e.g., polyethylene and polypropylene), derivates thereof, and copolymers thereof. Examples of polyolefin copolymers include ethylene-acrylic acid copolymers, polypropylene acrylic acid and polyethylene acrylic acid copolymers, polyethylene vinyl acetate copolymers, and blends of polyethylene and ethylene vinyl acetate. Homopolymers of ethylene vinyl acetate can also be used. Useful commercially available thermally activating adhesives include Primacor™ 3330 from Dow Chemcial, Polybond 1001 from BP Performance Polymers, Santoprene™ (dynamically vulcanized polyolefins) from Monsanto Chemical Company. The thermally activating adhesive adheres to thermoplastic and thermoset substrates. When exposed to heat and in a molten form, the thermally activating adhesive achieves a high degree of compatible interfacial mixing with a thermoplastic substrate. With a thermoset substrate, the molten thermally activating adhesive wets out the substrate surface resulting in a high strength bond between the two when cooled. The thermally activating adhesive may also contain fillers such as pigments, cross linking agents, viscosity agents, dispersants, antioxidants, plasticizers, and extrusion aids.

As stated above, photographic prints exposed to high or low humidity conditions will expand and contract. In order for the attachment mechanism to accommodate the expansion and contraction the photograph experiences, the attachment mechanism needs to be to sufficiently elastic. It should be noted that the concept of elasticity and stiffness are related. A highly elastic material will have a low stiffness and vice versa.

The inventors have discovered that the carrier film of the attachment mechanism can be chosen to accommodate the expansion and contraction of the photograph. The carrier film should be able to stretch and contract, i.e., should be sufficiently elastic, without applying sufficient lateral force to the photograph to cause substantial curling. Curling is substantial if it causes debonding or lifting of the repositionable adhesive from the display surface of more than about 3 mm after conditioned for seven days at about 23° C. and 20% relative humidity. Curl can be measured by the height of the highest region, typically a corner, of the photograph when laid on a flat surface.

The elastic properties, and thus the stiffness, of the carrier film are determined by the combination of its thickness and its Young's modulus. Suitable carrier films have a Young's modulus of about 0.5 giga-Pascal (GPa) or less. In one embodiment, the carrier film has a Young's modulus of about 0.1 GPa or less. In contrast, the printed literature and text books list a Young's modulus of 2.5 to 7 GPa for bond paper, such as paper used in photo copying machines. The present invention is inoperable when bond paper is used as the carrier film of the attachment mechanism. The thickness of the carrier film is less than about 200 micrometer and preferably less than about 100 micrometer.

The combination of the carrier film's thickness and its Young's modulus should be such that the stiffness of the carrier film is less than about 50,000 Newton per meter in its cross-web direction, as measured according to ASTM 882-02, Standard Test Method for Tensile Properties of Thin Plastic Sheeting. In another embodiment, the carrier film has a stiffness of less than about 20,000 Newton per meter in its cross-web direction, as measured according to ASTM 882-02. In brief summary, the test involves cutting a cross-web sample strip from a web of carrier film. The strip measures about 25 mm wide and 305 mm long. The initial separation distance of the jaws is about 254 mm. The ends of the strip are inserted into the jaws of an Instron Model 4464 stress-strain machine. The Instron machine pulls the strip apart (i.e., the jaw distance widens from its initial separation distance) at a rate of about 25.4 mm per minute. A graph of the load (in Newtons) versus the extension (in meters) of the sample strip is then plotted to generate a curve. A change in strain (Δ Strain) between two points on a linear portion of the curve is calculated as the change in separation of the jaw distance divided by the initial jaw separation distance. The change in load (Δ Load) between the same two points on the linear portion of the curve is recorded. The stiffness of the sample can then be calculated according to the following equation: Stiffness=(Δ Load÷W)÷(Δ Strain), where W represents the width of the sample over which the load is applied.

Suitable carrier films include tissue paper, natural polymer film, synthetic polymer film, woven fabric, and non-woven fabric. It should be noted that the stiffness of the carrier films can differ in the down web and cross web directions. Dimensional changes of a photograph, however, at high and low relative humidity conditions tend to be greater in the cross web direction than the down web direction. Thus, it is the cross web stiffness of the carrier film that is measured.

Suitable repositionable PSA that can be used in the present invention includes microsphere adhesives. An exemplary microsphere adhesive includes polyacrylic derivatives. The repositionable adhesive can be solvent based, water based, or can be a solventless, hot melt adhesive. Suitable repositionable adhesives includes those disclosed in the following U.S. Pat. No. 3,691,140 (Silver); U.S. Pat. No. 3,857,731 (Merrill et al.); U.S. Pat. No. 4,166,152 (Baker et al.); U.S. Pat. No. 4,495,318 (Howard); U.S. Pat. No. 5,045,569 (Delgado); U.S. Pat. No. 5,073,457 (Blackwell); U.S. Pat. No. 5,571,617 (Cooprider et al.), U.S. Pat. No. 5,663,241 (Takamatsu et al.); U.S. Pat. No. 5,714,327 (Cooprider et al.); US RE 37563 (Cooprider et al.); U.S. Pat. No. 5,756,625 (Crandall et al.); U.S. Pat. No. 5,824,748 (Kesti et al.); and U.S. Pat. No. 5,877,252 (Tsujimoto et al.).

The liner covers and protects the repositionable adhesive and the substrate until it is imaged and ready for display. The liner can be any paper or plastic sheet that bonds to the repositionable adhesive securely during storage and while passing through the feed mechanism of a printer. The liner releases cleanly and easily from the repositionable adhesive after the photo media has been imaged. The liner may be treated with a release coating to achieve the desired release performance. The release coating would be disposed on the first surface of the liner such that it would be disposed on the repositionable adhesive. Suitable coatings include are those that based on straight chain alkane derivatives, polydialkyl siloxane derivatives, or fluorocarbon derivatives. One exemplary release coating is described in U.S. Pat. No. 5,032,460 (Kantner et al.). The release coating will be applied on the liner, typically the entire surface area of the liner, to reach a dry coating weight of from 0.05 to 0.1 g/ft² (0.54 to 1.1 g/m²). Suitable silicone-based release liners are commercially available from Loparex, Inc., Willowbrook, Ill.

The repositionable adhesive backed photographs and photo media of the present invention can be further characterized by two adhesion tests: (1) adhesion to polyester (specifically polyethylene terephthalate), and (2) static angle test (SAT). Both are described below in detail.

The adhesion to polyester test is performed by laminating a 1.25 inch (32 mm) strip of plain polyester, product designation OR16 film from 3M Company, St. Paul, Minn., over the previously coated and dried sample of repositionable adhesive. The polyester is laminated to the adhesive by using a 2 kg rubber coated roller rolling at a rate of 12 inch/min (25.4 mm/min). Using a stress/strain gauge, such as one available from Instron Corp., the polyester film is pulled away from the adhesive at a 90° angle at a peel rate of 12 inch/min (305 mm/min). The peel force is recorded in grams/inch.

The SAT measures the ability of the photo media with its repositionable pressure sensitive adhesive to remain adhered on a standard test panel while being subjected to removal pressure at a specified peel angle under a constant load. The static angle test is one quantitative procedure for measuring detachment resistance of the photo media.

In performing static angle test, six photo media samples can be prepared using the following exemplary process. The samples are all the same size, 33 mm wide by 76 mm long. Each sample of photo media includes an adhesive stripe that is 18 mm wide by 33 mm long, where the long dimension of each adhesive stripe is positioned along the short dimension of, and at the top of, each photo media sample.

The test panel is a steel panel with a painted surface. Each sample is applied to the painted steel panel with the long dimension of the adhesive stripe horizontally oriented and located at the top of the photo media sample. Then, the sample is pressure adhered to the painted steel surface by two passes of an application roller with an application pressure of 1.5 pounds per square inch (77.6 mm of mercury).

The mounted sample is placed in a holder frame that is vertically oriented approximately perpendicular to a ground surface. The painted steel panel is held at a 30° downward angle relative to the vertically oriented frame. A 100 gram load is applied to the lower end of the photo media sample, proximate to the lower end of the holder frame. A timer is started upon application of the 100 gram load to measure how long the sample remains attached to the painted steel surface before the photo media sample detaches from the steel panel. The SAT usually runs to failure, i.e., until the sample actually detaches form the steel panel. The time to detachment is usually measured in seconds as the average of six results.

The repositionable photo media and repositionable photograph has an adhesion to polyester value of 300 gram/inch (11.8 gram/mm) or less, preferably less than 200 gram/inch (7.9 gram/mm), and more preferably less than 160 gram/inch (6.3 gram/inch), and a SAT value of 600 seconds or greater, preferably 1800 seconds or greater. The lower the adhesion to polyester value, the easier it will be to remove the photo media from the substrate to which it has been attached. The higher the SAT value, the more likely the photo media will remain adhered to the intended substrate once it has been applied.

### EXAMPLES

The stiffness of various carrier films was measured according to ASTM 882-02. The results are tabulated in Table 1. All the samples had a width of 0.025 meters except for Comparative Example A, wherein a narrower sample width of 0.005 m was used to keep the load measurements for all examples on the same scale.

The carrier film of Example 1 was a semi-crepe white tissue paper having a basis weight of about 13 grams per square meter having an average caliper of 38 micrometers and a Gurley porosity 22 by TAPPI test method 460. The paper was supplied from Burrows Paper Corporation, Little Falls, N.Y. and with an Internet website address of www.burrowspaper.com.

The carrier film of Example 2 was a Grade 85, 22 pound towel tissue paper supplied from SCA Tissues North America (Svenska Cellulosa Aktiebolaget, translating to Swedish Cellulose Incorporated), Neenah, Wis. and with an Internet website address of www.scatissue.com.

The carrier film of Example 3 was a spunbound polypropylene non-woven fabric having a basis weight of 34 grams per square meter. The non-woven fabric was supplied from Polymer Group, Inc., Charlotte, N.C. and with an Internet website of www.polymergroupinc.com.

The carrier film of Example 4 was a spunbond, meltblown, spunbond composite polypropylene non-woven fabric having a basis weight of 22 grams per square meter. The non-woven fabric was supplied from First Quality Nonwovens, Inc., Great Neck, N.Y. and with an Internet website address of www.fqnonwovens.com.

The carrier film of Comparative Example A was bond paper having a basis weight of 80 grams per square meter and an average thickness of 100 micrometer. The bond paper was supplied from Boise Cascade, LLC, Boise, Id. and with an Internet website address of www.bc.com.

TABLE 1

| | Δ Strain | Δ Load (N) | Stiffness (N/m) |
|---|---|---|---|
| Example 1 | 0.0047 | 1.85 | 15,440 |
| Example 2 | 0.0040 | 3.63 | 35,507 |
| Example 3 | 0.0232 | 2.91 | 4,935 |
| Example 4 | 0.0312 | 1.85 | 2,339 |
| Comparative A | 0.0031 | 3.85 | 243,970 |

As the data in Table 1 shows, carrier films of Examples 1 to 4, all had a stiffness value of less than 50,000 Newton per meter. Comparative Example A, however, had a stiffness value well in excess of 50,000 Newton per meter and thus would be too stiff (i.e., not elastic enough) to function as a carrier film in the attachment mechanism. In fact, a photograph having the attachment mechanism incorporating the carrier film of Comparative Example A curled through an angle of about 100 degrees after being conditioned in a low humidity, i.e., at 20% relative humidity, at 23° C. for four weeks.

Although specific embodiments of the present invention have been shown and described, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A method of making a repositionable adhesive backed photo media, the method comprising the steps of:
providing an imageable substrate having first and second opposing surfaces, the first surface capable of being imaged or providing a photograph having opposing first and second surfaces, the first surface containing an image, the second surface comprising a polyolefin layer;
providing an attachment mechanism comprising a carrier film having opposing first and second surfaces; a thermally activating adhesive disposed on the first surface of the carrier film; a repositionable adhesive disposed on the second surface of the carrier film; and a liner disposed on the repositionable adhesive;
stacking the imageable substrate or the photograph with the attachment mechanism such that its thermally activating adhesive contacts the second surface of the imageable substrate or the second surface of the photograph; and
exposing the stack to heat causing the thermally activating adhesive to bond to the second surface of the imageable substrate or the second surface of the photograph.

2. The method of claim 1 further comprising the step of applying a heat resistant film on the first surface of the imageable substrate or the first surface of the photograph prior to the exposing the stack to heat step.

3. The method of claim 2, wherein the heat resistant film is selected from the group consisting of polyimide, polyester, and paper.

4. The method of claim 1, wherein the carrier film has a stiffness of less than about 50,000 Newton per meter in its cross-web direction, as measured according to ASTM 882-02.

5. The method of claim 1, wherein the carrier film has a stiffness of less than about 20,000 Newton per meter in its cross-web direction, as measured according to ASTM 882-02.

6. The method of claim 1, wherein the carrier film is selected from the group consisting of tissue paper, natural polymer film, synthetic polymer film, woven fabric, and non-woven fabric.

7. The method of claim 6, wherein the non-woven fabric is selected from the group consisting of a spunbond fabric and a spunbond-meltblown fabric.

8. The method of claim 7, wherein at least one of the spunbond fabric and the spunbond-meltblown fabric is selected from the group consisting of polyethylene terephthalate, polypropylene, polyethylene, polyethylene terephthalate-cellulose acetate, and combinations thereof.

9. The method of claim 1, wherein the carrier film has a Young's modulus of less than about 0.5 GPa

10. The method of claim 1, wherein the carrier film has a Young's modulus of less than about 0.1 GPa.

11. The method of claim 1, wherein the carrier film has a basis weight of about 10 grams per square meter or greater.

12. The method of claim 1, wherein the carrier film has a basis weight of about 65 grams per square meter or less.

13. The method of claim 1, wherein the repositionable adhesive of the attachment mechanism is a polyacrylate, microsphere-based adhesive.

14. The method of claim 1, wherein the thermally activating adhesive is selected from the group consisting of polyethylene vinyl acetate copolymers, polyolefins, and polyamides.

15. The method of claim 1, wherein the repositionable adhesive has an adhesion to polyester of less than about 300 grams per inch and a static angle testing adhesion value of greater than about 600 seconds.

16. The method of claim 1, wherein the repositionable adhesive has an adhesion to polyester of less than about 200 grams/inch and a static angle testing adhesion value of greater than about 1800 seconds.

17. The method of claim 1, wherein the photo media exhibits substantially no curl when conditioned at 23 C in 20% relative humidity for seven days after being adhered to a substrate selected from the group consisting of smooth varnished wood, painted metal, cardboard, smooth vinyl wallpaper, semi-gloss painted dry wall, and flat painted drywall.

18. The method of claim 1, wherein before or after the exposing to heat step, the method further includes the step of imaging the first major surface of the imageable substrate, the imaging step selected from the group consisting of inkjet printing, thermal dye transfer printing, and electrophotographic printing.

19. A kit comprising:
a plurality of imageable substrate having first and second opposing major surfaces, the first surface capable of being imaged; and
a plurality of attachment mechanism, each comprising a carrier film having opposing first and second surfaces, a thermally activating adhesive disposed on the first surface and a repositionable adhesive disposed on the second surface of the carrier film and a liner disposed on the repositionable adhesive.

20. The kit of claim 1 further comprising a heat resistant film selected from the group consisting of polyimide, polyester, and paper.

21. The kit of claim 19, wherein the carrier film has a stiffness of less than about 50,000 Newton per meter in its cross-web direction, as measured according to ASTM 882-02.

22. The kit of claim 19, wherein the carrier film has a stiffness of less than about 20,000 Newton per meter in its cross-web direction, as measured according to ASTM 882-02.

23. The kit of claim 19, wherein the carrier film has a Young's modulus of less than about 0.5 GPa

24. The kit of claim 19, wherein the carrier film has a Young's modulus of less than about 0.1 GPa.

25. The kit of claim 19, wherein the repositionable adhesive has an adhesion to polyester of less than about 300 grams per inch and a static angle testing adhesion value of greater than about 600 seconds.
